(19) United States
(12) Patent Application Publication
(10) Pub. No.: US 2002/0195485 A1
(43) Pub. Date: Dec. 26, 2002

(54) Point-of-sale transaction system

(76) Inventors: Daniel Guy Pomerleau, Calgary (CA); Dusty Keashly, Calgary (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 09/885,050

(22) Filed: Jun. 21, 2001

(51) Int. Cl. G06F 17/60

(52) U.S. Cl. 235/379

(57) ABSTRACT

The invention relates to a portable point-of-sale transaction method and system allowing information from a cheque to be scanned for reporting to a cheque clearing service. In particular, the system includes a portable scanner for scanning information relating to a transaction, a portable point-of-sale terminal (POST) for receiving the information, for reporting information to a transaction approval service and for receiving transaction approval or denial from the transaction approval service.

### FIELD OF THE INVENTION

The invention relates to a portable point-of-sale transaction method and system allowing information from a cheque to be scanned for reporting to a cheque clearing service.

### BACKGROUND OF THE INVENTION

In many countries, including the United States, the financial services industry is composed of many different providers including banks, trust companies and other financial institutions. As a result of the large number of institutions, many of them are incapable of efficiently managing electronic transactions between different institutions. For example, a consumer having an account and debit card with one institution would A often be unable to effect an electronic transaction with a merchant having an account with a different institution. This inability is a result of the different institutions not having compatible transaction management systems allowing inter-institution account-account transactions. Accordingly, as a result of this lack of compatibility of transaction management systems, there is a relatively low use of debit cards for transactions in the United States with consumers instead relying on traditional payment means including personal cheques. In other jurisdictions, including Canada, the use of personal cheques has dropped considerably for certain types of transactions but remains heavily used for other types of transactions.

The main concerns with the use of personal cheques is the ability of the payee, usually a merchant, to verify that a payor's account has the promised funds and ultimately that the cheque will clear. Accordingly, most stores or merchants before accepting a cheque will require additional security information about the customer. For example, some stores require that a customer be pre-approved to use cheques and issue store-specific chequing card as security for the cheque being written. Other stores may require a driver's license and/or credit card information and hope for the best.

As a result of this inadequate security, cheque clearing systems or services have been implemented to provide merchant's with different levels of service for clearing cheques. A merchant in subscribing to a cheque clearing service may be able select different levels of cheque clearing security and pay different fees for that level of service.

Basic or first level of cheque authorization uses the person's driver's license and/or credit card number to investigate if the consumer has a history of bad cheques as may have been reported to credit bureaus. This first level of service would not utilize the specific information on the cheque including the account number and bank identifying information (routing code).

Second level cheque authorization verifies that the consumer's account exists and is not closed. At this level of security the cheque routing code is read from the cheque and is sent to the cheque clearing service which will use this information to request the account information from the consumer's financial institution which is then reported back to the merchant.

Third level cheque authorization is a cheque guarantee whereby the funds in the specific account are verified and held for payment of the cheque. As with the second level the cheque routing code is read as well as the transaction amount entered and sent to the cheque clearing service which uses this information to place a hold on an account for a specific amount until the cheque is received.

As indicated above, cheques have their account information and bank routing codes encoded in a string at the bottom of the cheque. This string is encoded using a special magnetic ink with a font that is both optically (Optical Character Recognition—OCR) and magnetically (Magnetic Ink Character Recognition—MICR) readable. However, in order to provide high speed processing capabilities, the typical method of processing cheques involves using a magnetic head to read the information. For magnetic reading to occur, the magnetic head must pass over the encoded string at a constant speed—unlike a magnetic stripe where the information is encoded with a modulation scheme that allows the information to be read at several varying speeds. To satisfy the constant speed requirement, magnetic head cheque readers incorporate a motor to move either the cheque (most typical) or the head at a constant rate. These motor driven readers tend to be very bulky and power hungry making them unsuitable for portable applications. Some of these merchants have used the mechanical readers for obtaining the relevant cheque information.

The American Banking Association sets as its standard the E13-B font for cheques. As the E13-B font is also optically readable, it is possible to obtain the cheque information with an optical scanner.

Optical scanning is presently in use with a product called IRISPen (I.R.I.S., Inc., Boca Raton, Fla.) (http://www.scaniris.com/US/Products/irispen.html) which uses an externally connected computer to process the scanned image into characters. However, while this system allows cheque information to be effectively gathered, the system is not portable.

Accordingly, there has been a need for a portable cheque scanning device which incorporates font recognition into a portable device particularly for use with a wireless point-of-sale (WPOS) system.

While OCR scanning does not verify the presence of the magnetic ink, the recent availability of magnetic ink toner cartridges for laser printers for companies desiring to automate their cheque printing lessens the value of the additional security measure of magnetic ink as anyone having a magnetic ink toner cartridge and cheque software could easily print a phony cheque. As a result, the only effective method of verifying the validity of a cheque is through on-line authorization.

Since the cheque string length is typically over 20 characters, it is difficult to manually enter the characters without errors. Accordingly, there is a need for a system which permits rapid and accurate entry of the character string.

Further, and for higher levels of cheque security, there is also a need for a system enabling rapid entry of other information including a person's name, address and phone number using OCR technology. Alternatively, or in conjunction with such a system there is a need for a POST enabling the user information within a magnetic stripe of a customer's bank card, credit card or driver's license to be utilized for cheque security processing. Still further, and as an alternative, or in conjunction with such a system, there is also a need for a POST enabling the user information within a bar code of a customer's store card or driver's license to be utilized for cheque security processing or for invoice information tracking. Still further, there is a need for a system in which a person's signature or other handwriting on a cheque can be obtained for security purposes.

### SUMMARY OF THE INVENTION

In accordance with the invention, there is provided a point-of-sale transaction system comprising:

a portable scanner for scanning information relating to a transaction;

a portable point-of-sale terminal (POST) in operative communication with the portable scanner for receiving the information, the POST also for reporting information to a transaction approval service and for receiving transaction approval or denial from the transaction approval service

wherein any one of or a combination of the portable scanner or POST formats the information for reporting to transaction approval service.

In further embodiments, the scanner is in operative communication with the POST via a wireless link and/or the scanner includes:

a processor operatively connected to a reader for processing scanned information and wherein the scanned information is any one of or a combination of text, code or handwriting;

an interface operatively connected to the processor for operative communication with the POST; and,

wherein the processor receives a digital image of the text, code and/or handwriting information and formats the text, code and/or handwriting information for sending to the POST via the interface.

In a further embodiment, the scanned information is the routing code from a cheque and the processor converts a digital image of the routing code to a formatted string. Still further, in another embodiment, the processor compares the formatted string to a library of jurisdictional codes to determine if the formatted string corresponds to a jurisdictional code.

Further still, the scanner may include a display operatively connected to the processor for displaying instructions or information to a user relating to the transaction and/or the POST may include a card reader for reading information from any one of or a combination of a debit card, credit card or smart card.

In a more specific embodiment, the invention provides a point-of-sale transaction system comprising:

a portable scanner for scanning information relating to a transaction; the scanner including

a processor operatively connected to a reader for processing scanned information and wherein the scanned information is any one of or a combination of text, code or handwriting;

an interface operatively connected to the processor;

a display operatively connected to the processor for displaying instructions or information to a user relating to the transaction; and,

wherein the processor receives a digital image of the text, code and/or handwriting information and formats the text, code and/or handwriting;

a portable point-of-sale terminal (POST) in operative communication with the portable scanner via a wireless link, the POST for receiving the scanned information, the POST also for reporting information to a transaction approval service and for receiving transaction approval or denial from the transaction approval service.

In another aspect of the invention, a method of obtaining approval for a cheque transaction between a payor and a payee is provided comprising the steps of:

a) scanning cheque information from a cheque with a portable scanner;

b) reporting the scanned cheque information to a point-of-sale terminal (POST);

c) establishing an operative connection between the POST and a cheque clearing service;

d) transferring the scanned cheque information to the cheque clearing service; and,

e) receiving transaction approval or denial at the POST from the cheque clearing service.

In a further embodiment, the invention includes printing a receipt at the POST.

In a further embodiment, the invention also provides that after step a) the processor compares a scanned code with a library of jurisdictional codes to determine if the formatted string corresponds to a jurisdictional code and/or the step of a payee entering the amount of the transaction into the POST or scanner for formatting and reporting to the cheque clearing service.

In a more specific embodiment, the invention provides a method of obtaining approval for a cheque transaction between a payor and a payee comprising the steps of:

scanning cheque information from a cheque with a portable scanner wherein the cheque information includes any one of or a combination of text, code or handwriting;

entering a transaction amount on the POST;

reporting the scanned cheque information to a point-of-sale terminal (POST);

establishing an operative connection between the POST and a cheque clearing service;

transferring the scanned cheque information and the transaction amount to the cheque clearing service; and,

receiving transaction approval or denial at the POST from the cheque clearing service.

### BRIEF DESCRIPTION OF THE DRAWINGS

These and other features of the invention are described with reference to the drawings wherein:

FIG. 1 is a schematic overview of a cheque verification system in accordance with the invention;

FIG. 2 is a schematic overview of a method of cheque verification on a point-of-sale terminal in accordance with the invention;

FIG. 3 is a schematic overview of a method of cheque verification on a scanner in accordance with the invention; and,

FIG. 4 is a schematic overview of a cheque scanner in accordance with the invention.

### DETAILED DESCRIPTION OF THE INVENTION

In accordance with the invention and with reference to the figures, a portable cheque authorization system for field/mobile purchases is provided. More specifically, the invention provides a handheld device capable of reading cheque information such as a cheque routing code and transferring the code information to a point of sale terminal whereupon the POS application software will contact a cheque processing/authorization service to obtain purchase approval of the cheque. The system may be used for collecting other information including text and/or handwriting.

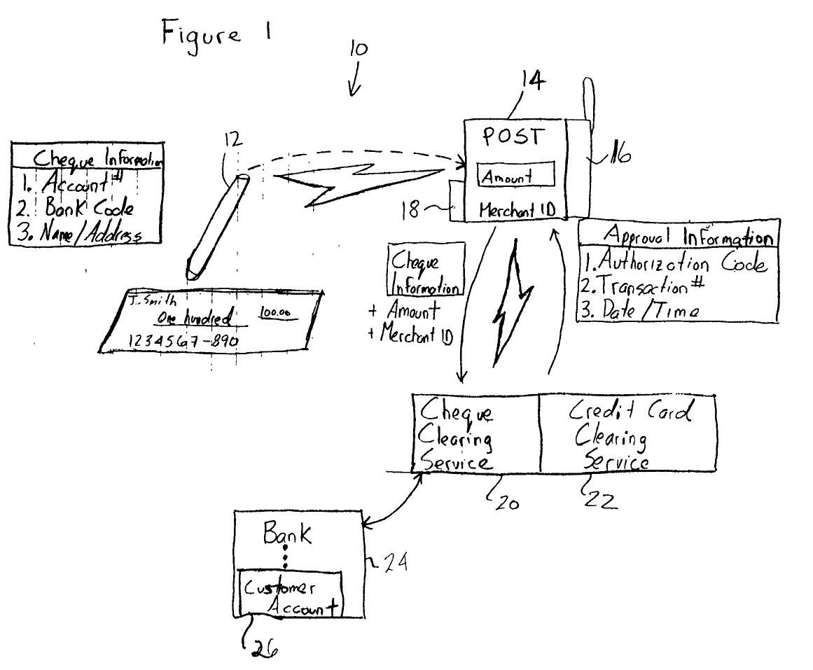

With reference to FIG. 1, the system 10 includes an OCR pen 12 in operative communication with a point-of-sale terminal (POST) 14. The POST 14 is preferably a wireless POST having cell phone 16 and card-swipe functionality 18 as described in applicant's co-pending application PCT CA 00/01370. The pen 12 may be wired to the POST 14 or may communicate via a wireless connection such as infra-red or Bluetooth. The POST 14 can connect via a wired or wireless network to either a cheque clearing service 20 or credit card clearing service 22 for obtaining approval for a transaction. With respect to the cheque clearing service 20, the customer's bank 24 may be contacted, depending on the cheque processing service level desired, to verify the existence of an account 26 and/or to place a hold on specific funds in that account and, hence, deliver approval information back to the POST 14.

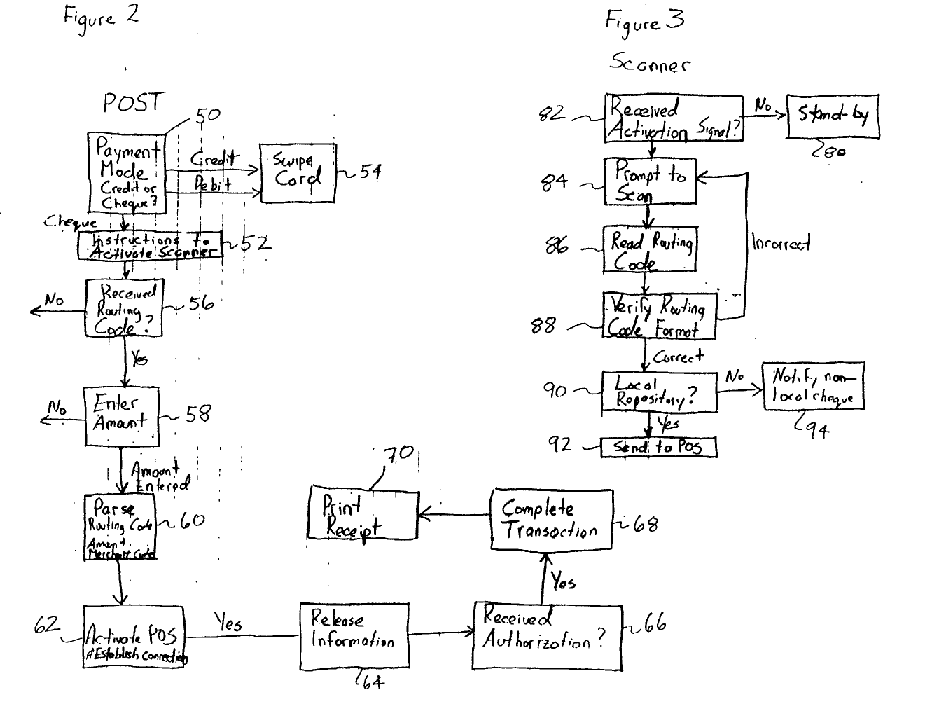

With reference to FIG. 2, at the start of a transaction, a merchant or customer desiring to use a POST having the cheque scanning capabilities will be prompted to select a payment mode (box 50), for example, credit, debit or cheque. If cheque is selected, the POST prompts the merchant to activate the scanner to scan the cheque information (box 52) whereupon the POST enters a mode awaiting the receipt of cheque information (box 56), such as routing information. Alternatively, if debit or credit is selected, the merchant is prompted to swipe the customer's card (box 54).

If the cheque information is received, the POST 14 may optionally prompt the merchant to enter the transaction amount (box 58) depending on the level of cheque processing service required or subscribed to by the merchant. If all necessary information has been obtained, the POST 14 parses the required information (box 60) including the routing code, merchant number and the amount (if required) and activates the data communications link (box 62) to connect the POST to the cheque clearing service 20. If an appropriate connection with the cheque clearing service 20 is established, the POST releases the parsed information (box 64) to the cheque clearing service for authorization.

The cheque clearing service 20 determines if transaction approval is to be granted and delivers the approval/denial information to the POST. If the POST receives authorization (box 66), the POST completes the transaction (box 68) and may optionally print a receipt (box 70) for a customer and/or merchant record of the transaction.

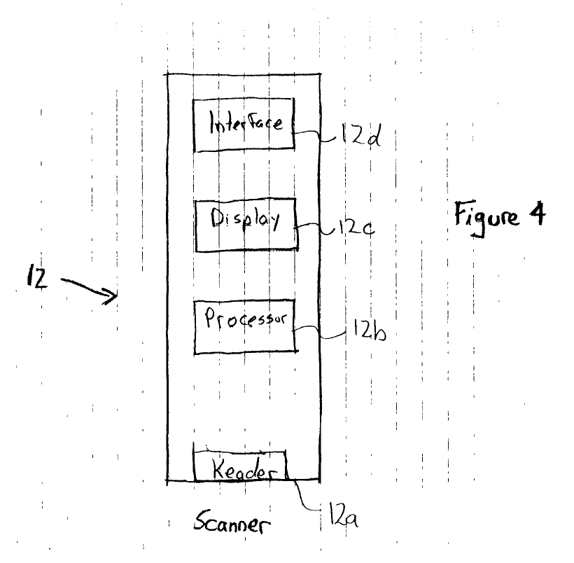

With reference to FIGS. 3 and 4, the scanner 12 is normally in a powered down (off) mode (box 80) awaiting activation by the merchant.

The scanner 12 generally includes a reader 12a, a processor 12b, a display 12c and an interface 12d.

When activated, the scanner may prompt the merchant to scan the cheque (box 84) whereby the scanner reads the desired character information from the cheque (box 86). The reader 12a is placed over cheque information such as the routing code of a cheque and/or other textual/barcode information and captures a digital image of the information (box 86). The processor 12b converts the digital image of the information into a character string (if scanned information is text) using known optical character recognition methodology.

In various embodiments of the invention depending on the type of information being scanned, the processor 12b may perform different information processing functions. For example, the character string may be verified against specific string formats for accuracy (box 88). Accuracy verification may include a comparison of the scanned character string against a database of acceptable formats such as those formats assigned to a specific financial jurisdiction (box 90). If the accuracy of the character string is confirmed, the character string is sent to the POST 14 via the interface 12d (box 92). Alternatively, if the format of the character string does not conform to the expected string formats, the scanner may notify the merchant to rescan the cheque information. Alternatively, if the jurisdiction code fails to match to a specific jurisdiction, the scanner may notify the merchant that the cheque is a non-local cheque (box 94) and suggest that the merchant manually or visually inspect the cheque to determine if there are any signs that the cheque may have been altered or otherwise tampered with before allowing the information to be transferred to the POST. In the event that the jurisdiction code does not match, the merchant may permit the information to be transferred in case it is a legitimate out-of-state cheque, however, the merchant may request further information from the customer.

In another embodiment, the scanner may be used to obtain user information from a different font text or a bar code, and accordingly, may include other text or bar code de-coding software.

In a further embodiment, the scanner may be used to obtain a digital image of a person's signature. In this embodiment, the digital image of the signature may be formatted for sending to the cheque clearing service which would compare the scanned signature with a signature on file.

The above method describes particular information displays to the user. It is however, understood that various information with respect to the initiation, processing or transfer stages of character string capture may be displayed to the user on display 12c which are not specifically described above. Furthermore, it is also understood that the above functionalities may be distributed between the scanner and POST as would be understood by a worker skilled in the art. That is, the scanner may only capture and transfer the basic digital image of the desired information with all display and other intelligent functions including jurisdiction code comparisons being performed on the POST. Alternatively, the scanner may include additional functions such as parsing functions.

1. A point-of-sale transaction system comprising:
a portable scanner for scanning information relating to a transaction;
a portable point-of-sale terminal (POST) in operative communication with the portable scanner for receiving the information, the POST also for reporting information to a transaction approval service and for receiving transaction approval or denial from the transaction approval service
wherein any one of or a combination of the portable scanner or POST formats the information for reporting to transaction approval service.

2. A point-of-sale transaction system as in claim 1 wherein the scanner is in operative communication with the POST via a wireless link.

3. A point-of-sale transaction system as in claim 1 wherein the scanner includes:
a processor operatively connected to a reader for processing scanned information and wherein the scanned information is any one of or a combination of text, code or handwriting on a cheque;
an interface operatively connected to the processor for operative communication with the POST; and,
wherein the processor receives a digital image of the text, code and/or handwriting information and formats the text, code and/or handwriting information for sending to the POST via the interface.

4. A point-of-sale transaction system as in claim 3 wherein the scanned information is the routing code from a cheque and the processor converts a digital image of the routing code to a formatted string.

5. A point-of-sale transaction system as in claim 4 wherein the processor compares the formatted string to a library of jurisdictional codes to determine if the formatted string corresponds to a jurisdictional code.

6. A point-of-sale transaction system as in claim 3 wherein the scanner includes a display operatively connected to the processor for displaying instructions or information to a user relating to the transaction.

7. A point-of-sale transaction system as in claim 3 wherein the POST includes a card reader for reading information from any one of or a combination of a debit card, credit card or smart card.

8. A point-of-sale transaction system comprising:
a portable scanner for scanning information relating to a transaction; the scanner including
a processor operatively connected to a reader for processing scanned information and wherein the scanned information is any one of or a combination of text, code or handwriting;
an interface operatively connected to the processor;
a display operatively connected to the processor for displaying instructions or information to a user relating to the transaction; and,
wherein the processor receives a digital image of the text, code and/or handwriting information and formats the text, code and/or handwriting;
a portable point-of-sale terminal (POST) in operative communication with the portable scanner via a wireless link, the POST for receiving the scanned information, the POST also for reporting information to a transaction approval service and for receiving transaction approval or denial from the transaction approval service.

9. A method of obtaining approval for a cheque transaction between a payor and a payee comprising the steps of:
a) scanning cheque information from a cheque with a portable scanner;
b) reporting the scanned cheque information to a point-of-sale terminal (POST);
c) establishing an operative connection between the POST and a cheque clearing service;
d) transferring the scanned cheque information to the cheque clearing service; and,
e) receiving transaction approval or denial at the POST from the cheque clearing service.

10. A method as in claim 9 further comprising the step of printing a receipt at the POST.

11. A method as in claim 9 wherein the portable scanner includes a processor and wherein after step a) the processor compares a scanned code with a library of jurisdictional codes to determine if the formatted string corresponds to a jurisdictional code.

12. A method as in claim 9 wherein a payee enters the amount of the transaction into the POST or scanner for formatting and reporting to the cheque clearing service.

13. A method of obtaining approval for a cheque transaction between a payor and a payee comprising the steps of:
a) scanning cheque information from a cheque with a portable scanner wherein the cheque information includes any one of or a combination of text, code or handwriting;
b) entering a transaction amount on the POST;
c) reporting the scanned cheque information to a point-of-sale terminal (POST);
d) establishing an operative connection between the POST and a cheque clearing service;
e) transferring the scanned cheque information and the transaction amount to the cheque clearing service; and,
f) receiving transaction approval or denial at the POST from the cheque clearing service.
